(19) United States
(12) Patent Application Publication
(10) Pub. No.: US 2013/0027684 A1
(43) Pub. Date: Jan. 31, 2013

(54) EXPOSURE APPARATUS, SUBSTRATE PROCESSING APPARATUS, AND DEVICE MANUFACTURING METHOD

(71) Applicants: Tohru Kiuchi, Niiza-shi (JP); Hideo Mizutani, Yokohama-shi (JP)

(72) Inventors: Tohru Kiuchi, Niiza-shi (JP); Hideo Mizutani, Yokohama-shi (JP)

(21) Appl. No.: 13/640,875

(22) PCT Filed: Apr. 13, 2011
(86) PCT No.: PCT/JP2011/059189

§ 371 Date: Oct. 12, 2012

Related U.S. Application Data
(60) Provisional application No. 61/323,514, filed on Apr. 13, 2010.

(51) Int. Cl. G03B 27/54; G03B 27/58

(52) U.S. Cl. 355/67; 355/72; 355/77

(57) ABSTRACT

An exposure apparatus that transfers a pattern provided along a predetermined cylindrical surface onto a substrate while rotating the pattern in a circumferential direction of the cylindrical surface is provided, which includes a first projection optical system that projects an image of a first partial pattern of the pattern which is disposed in a first area of the cylindrical surface onto a first projection area, a second projection optical system that projects an image of a second partial pattern of the pattern which is disposed in a second area different from the first area onto a second projection area different from the first projection area, and a guide device that guides the substrate to the first projection area and the second projection area in synchronization with a rotation of the pattern in the circumferential direction.

### TECHNICAL FIELD

The present invention relates to an exposure apparatus, a substrate processing apparatus, and a device manufacturing method.

Priority is claimed on U.S. Provisional Patent Application No. 61/323,514 filed in the United States Patent and Trademark Office on Apr. 13, 2010, the contents of which are incorporated herein by reference.

### BACKGROUND ART

As a display element that constitutes a display device such as a display apparatus, for example, a liquid crystal display element and an organic electroluminescence (organic EL) element are known. Recently, as such a display element, an active element (active device) that forms a thin film transistor (TFT) on the surface of a substrate in response to each pixel has become the mainstream.

Recently, a technology to form a display element on a substrate having flexibility (for example, a film member or the like) has been proposed. As such a technology, for example, a technique called a roll-to-roll method (hereinafter, simply described as a “roll method”) is known (for example, see PTL 1). In the roll method, a substrate is transported in a manner that the belt-shaped substrate wound on a supply roller on a substrate supply side is sent out while the substrate that has been sent out is wound on a recovery roller on a substrate recovery side.

### CITATION LIST

### Patent Literature

[PTL 1] PCT International Publication No. WO 2008/129819

### SUMMARY OF INVENTION

### Technical Problem

However, a large-sized display screen is expected in a display device, and even in the above-described roll method, a technology that can efficiently manufacture a large-sized display element on a belt-shaped substrate has been demanded.

In an aspect of the present invention, an object of the invention is to provide an exposure apparatus, a substrate processing apparatus, and a device manufacturing method, which can efficiently manufacture a display element on a belt-shaped substrate.

### Solution to Problem

In a first aspect of the present invention, an exposure apparatus which transfers a pattern that is provided along a predetermined cylindrical surface onto a substrate while rotating the pattern in a circumferential direction of the cylindrical surface, includes a first projection optical system that projects an image of a first partial pattern of the pattern which is disposed in a first area of the cylindrical surface onto a first projection area; a second projection optical system that projects an image of a second partial pattern of the pattern which is disposed in a second area different from the first area onto a second projection area different from the first projection area; and a guide device that guides the substrate to the first projection area and the second projection area in synchronization with a rotation of the pattern in the circumferential direction.

In a second aspect of the present invention, a substrate processing apparatus which processes a belt-shaped substrate, includes a substrate transport portion that transports the substrate in a length direction of the substrate; and a substrate processing portion that is provided along a transport path of the substrate by the substrate transport portion and performs processing of the substrate that is transported along the transport path, wherein the substrate processing portion includes the exposure apparatus that transfers the pattern onto the substrate.

In a third aspect of the present invention, a device manufacturing method for manufacturing a device through processing of a substrate, includes transferring a pattern onto the substrate using the exposure apparatus; and processing the substrate onto which the pattern has been transferred on the basis of the pattern.

### Advantageous Effects of Invention

According to the aspects of the present invention, the exposure apparatus, the substrate processing apparatus, and the device manufacturing method, which can efficiently manufacture the display element on the belt-shaped substrate, can be provided.

### BRIEF DESCRIPTION OF DRAWINGS

FIG. 1 is a schematic view illustrating the configuration of a substrate processing apparatus according to an embodiment of the present invention.

FIG. 2 is a schematic view illustrating the configuration of an exposure apparatus according to an embodiment of the present invention.

FIG. 3 is a perspective view illustrating the partial configuration of an exposure apparatus according to an embodiment of the present invention.

FIG. 4A is a perspective view illustrating the partial configuration of an exposure apparatus according to an embodiment of the present invention.

FIG. 4B is a perspective view illustrating the partial configuration of an exposure apparatus according to an embodiment of the present invention.

FIG. 5 is a perspective view illustrating the partial configuration of an exposure apparatus according to an embodiment of the present invention.

FIG. 6 is a plan view illustrating the partial configuration of an exposure apparatus according to an embodiment of the present invention.

FIG. 7 is a schematic view illustrating the partial configuration of an exposure apparatus according to an embodiment of the present invention.

FIG. 8 is a plan view illustrating the partial configuration of an exposure apparatus according to an embodiment of the present invention.

FIG. 9 is a view illustrating the operation of an exposure apparatus according to an embodiment of the present invention.

FIG. 10 is a view illustrating another configuration of an exposure apparatus according to an embodiment of the present invention.

FIG. 11 is a view illustrating another configuration of an exposure apparatus according to an embodiment of the present invention.

FIG. 12 is a view illustrating another configuration of an exposure apparatus according to an embodiment of the present invention.

FIG. 13 is a view illustrating another configuration of an exposure apparatus according to an embodiment of the present invention.

FIG, 14 is a view illustrating another configuration of an exposure apparatus according to an embodiment of the present invention.

FIG. 15 is a view illustrating another configuration of an exposure apparatus according to an embodiment of the present invention.

FIG. 16 is a view illustrating another configuration of an exposure apparatus according to an embodiment of the present invention.

FIG. 17 is a view illustrating another configuration of an exposure apparatus according to an embodiment of the present invention.

FIG. 18 is a flowchart illustrating a part of a manufacturing process when a semiconductor device is manufactured.

FIG. 19 is a flowchart illustrating a part of a manufacturing process when a liquid crystal display element is manufactured.

### DESCRIPTION OF EMBODIMENTS

Hereinafter, embodiments of the present invention will be described with reference to the accompanying drawings.

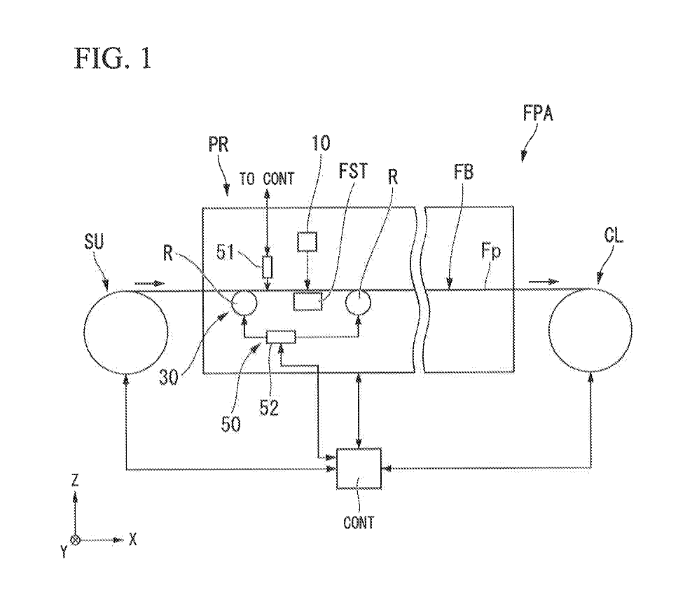

FIG. 1 is a view illustrating the configuration of a substrate processing apparatus FPA according to an embodiment of the present invention.

As shown in FIG. 1, a substrate processing apparatus FPA includes a substrate supply portion SU supplying a belt-shaped substrate (for example, belt-shaped film member) FB, a substrate processing portion PR processing a surface (surface to be processed) of the substrate FB, a substrate recovery portion CL recovering the substrate FB, and a control portion CONT controlling the above-described portions.

In this embodiment, as shown in FIG. 1, an XYZ coordinate system is set, and description will be made hereinafter appropriately using the XYZ coordinate system. The XYZ coordinate system, for example, has an X axis and a Y axis that are set along a horizontal surface, and a Z axis that is set upwardly in a vertical direction. Further, the substrate processing device FPA transports the substrate FB from a minus side (−side) to a plus side (+side) along the X axis as a whole. At this time, the width direction (long strip of paper direction) of the belt-shaped substrate FB is set to the Y-axis direction.

The substrate processing apparatus FPA is an apparatus that executes various kinds of processes on the surface of the substrate FB until the substrate FB is recovered by the substrate recovery portion CL after the substrate FPA is sent out from the substrate supply portion SU. The substrate processing apparatus FPA may be used, for example, when a display element (electronic device) such as an organic EL element and a liquid crystal display element on the substrate FB.

In the substrate processing apparatus FPA, as the substrate FB to be processed, for example, a leaf (foil) of a resin film or stainless steel may be used. For example, the resin film may be made using materials, such as polyethylene resin, polypropylene resin, polyester resin, ethylene vinyl copolymer resin, polychlorinated vinyl resin, cellulose resin, polyamide resin, polyimide resin, polycarbonate resin, polystyrene resin, and vinyl acetate resin.

It is preferable that the substrate FB have a small coefficient of thermal expansion so that dimensions of the substrate FB do not change even if the substrate FB receives heat of about 200° C. For example, the coefficient of thermal expansion can be lowered by mixing inorganic filler with a resin film. Examples of inorganic filler may be titanium oxide, zinc oxide, alumina, and silicon oxide.

The dimensions in the width direction (long strip of paper direction) of the substrate FB are formed, for example, in the range of 1 m to 2 m, and the dimensions in the length direction (lengthiness direction) of the substrate FB are thrilled, for example, to be equal to or larger than 10 m. Of course, these dimensions are merely exemplary, and the dimensions of the substrate FB are not limited thereto. For example, the dimensions of the substrate FB in the Y direction may be equal to or smaller than 50 cm, or may be equal to or larger than 2 m. Further, the dimensions of the substrate FB in the X direction may be equal to or smaller than 10 m.

The substrate FB is formed to have flexibility. Here, the flexibility means the property that the substrate FB is flexible without being cracked or broken even if power of the tare weight degree is added to the substrate FB. Further, the property that the substrate FB is bent by the power of the tare weight degree is included in the flexibility. The flexibility varies depending on the material, size, and thickness of the substrate or environment such as temperature. As the substrate FB, one sheet of belt-shaped substrate may be used, or a plurality of unit substrates may be connected to make a belt shape.

The substrate supply portion SU sends out and supplies the substrate FB that is wound, for example, in a roll shape to the substrate processing portion PR. In this case, in the substrate supply portion SU, a shaft portion winding the substrate FB thereon and a rotary driving device rotating the shaft portion are provided. In addition, for example, a cover portion covering the roll-shaped substrate FB in the wound state may be provided, The substrate supply portion SU is not limited to a mechanism that sends out the roll-shaped substrate FB in the wound state, but may include a mechanism that sequentially sends out the belt-shaped substrate FB in the length direction.

The substrate recovery portion CL recovers the substrate FB from the substrate processing portion PR, for example, by winding the substrate FB in the roll shape. In the same manner as the substrate supply portion SU, a shaft portion winding the substrate FB thereon, a rotary driving device rotating the shaft portion, and a cover portion covering the recovered substrate FR are provided in the substrate recovery portion CL. In the case of cutting the substrate FB in a panel shape, the substrate processing portion PR may recover the substrate FB in a state unlike the state where the substrate FB is wound in the roll shape, that is, in a state where the substrates FB are repeated.

The substrate processing portion PR transports the substrate FB that is supplied from the substrate supply portion SU to the substrate recovery portion CL and processes a surface Fp to be processed of the substrate FB in the transport process. The substrate processing portion PR is composed of, for example, a processing device 10, a transport device 30, and an alignment device 50.

The processing device 10 is provided with various devices for forming, for example, an organic EL element with respect to the surface Fp to be processed of the substrate FB. Such devices may be a partition forming device for forming a partition on the surface Fp to be processed, an electrode forming device for forming an electrode, and a light-emitting layer forming device for forming a light-emitting layer. More specifically, such devices may be a droplet application device (for example, ink-jet type application device or a spin coat type application device), a film forming device (for example, vapor deposition device or sputtering device), an exposure apparatus, a developing device, a surface reforming device, and a washing device. These devices are properly provided along the transport path of the substrate FB. In this embodiment, an exposure apparatus is provided as the processing device 10.

The transport device 30 is provided with a roller device R that transports the substrate FB to the side of the substrate recovery portion CL in the substrate processing portion PR. A plurality of roller devices R are provided along the transport path of the substrate FB. On at least a part (roller device R) of the plurality of roller devices R, a driving mechanism (not shown) is mounted. As the roller device R is rotated, the substrate FB is transported in the X-axis direction. The part (roller device R) of the plurality of roller devices R may movably be provided in a direction in which the part (roller device R) crosses the surface of the substrate FB.

The alignment device 50 performs an alignment operation with respect o the substrate FB. The alignment device 50 is provided with an alignment camera 51 detecting the position of the substrate FB, and an adjustment device 52 adjusting at least one of the position and the posture of the substrate FB based on the result of the detection by the alignment camera 51.

For example, the alignment camera 51 detects an alignment mark formed on the substrate FB and transmits the result of the detection to the control portion CONT. The control portion CONT obtains position information of the substrate FB based on the result of the detection, and controls the adjustment amount through the adjustment device 52 based on the position information.

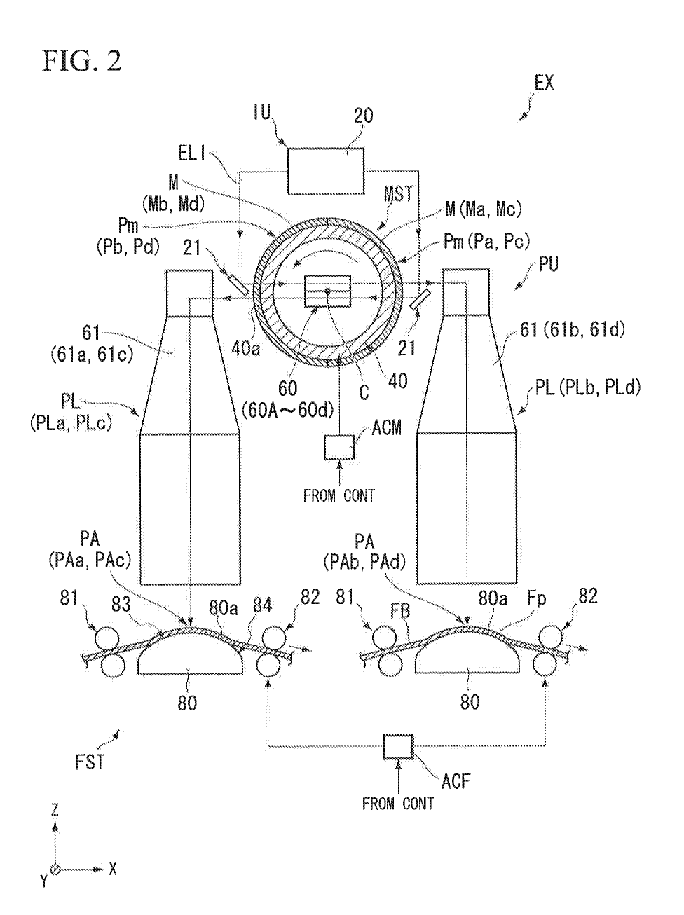

FIG. 2 is a view illustrating the configuration of an exposure apparatus EX that is used as the processing apparatus 10. The exposure apparatus EX is an apparatus that projects an image of a pattern Pm formed on a mask M onto the substrate FB. The exposure apparatus EX, as shown in FIG. 2, includes an illumination device IU illuminating the mask M, a mask moving device MST maintaining, moving, and rotating the mask M, a projection device PU projecting an extended image of the pattern Pm onto the substrate FB, and a substrate guide device PSI guiding the substrate FB.

The illumination device IU illuminates an exposure light ELI on the mask M. The illumination device IU is provided with a light source device 20 and an irradiation optical system 21. The exposure light ELI emitted from the light source device 20 is irradiated from a plurality of directions to the mask M through the illumination optical system 21. Further, the irradiation optical system 21, although simply shown in FIG. 2, actually includes a plurality of optical elements that guide the exposure light ELI.

The mask moving device MST is provided with a maintenance portion 40 and a driving device ACM. The maintenance portion 40 is roughly in a cylindrical shape, and the mask M is maintained along a cylindrical surface 40a that corresponds to the circumferential surface of the maintenance portion 40. The maintenance portion 40 is provided to be rotatable along the circumferential direction of the cylindrical surface 40a (that is, around the axis line C as the center axis line of the cylindrical surface 40a). The driving device ACM may rotate the maintenance portion 40 along the cylindrical surface 40a, and move the maintenance portion 40 in the X, Y, and Z directions in the drawing.

The mask M is detachably maintained by the maintenance portion 40. As the mask M, for example, a transmission mask that is formed in a sheet shape is used. The mask M is maintained by the maintenance portion 40 so that the pattern surface on which the pattern Pm is formed is directed toward the inside of the cylindrical surface 40a to make the pattern Pm disposed along the cylindrical surface 40a. Through this, the pattern Pm is actually disposed on the surface that coincides with the cylindrical surface 40a.

The projection device PU has a plurality of projection optical systems PL. One part of the plurality of projection optical systems PL is disposed on the upstream side (−X side) of the substrate FB with respect to the mask M, and projects the extended image of the pattern Pm that is disposed on +X side of the maintenance portion 40 onto the substrate FB that is positioned further to the −X side than the maintenance portion 40. Further, the other part of the plurality of projection optical systems PL is disposed on the downstream side (+X side) of the substrate FB with respect to the mask M, and projects the extended image of the pattern Pm that is disposed on −X side of the maintenance portion 40 onto the substrate FB that is positioned further to the +X side than the maintenance portion 40.

Each of the projection optical systems PL is provided with a first image forming portion 60 and a second image forming portion 61. The first image forming portion 60 is provided in an area on the inner side of the cylindrical maintenance portion 40 (hereinafter properly called the “inside of the maintenance portion 40”). The first image forming portion 60 emits the exposure light that transmits the mask M and is incident to the inside of the maintenance portion 40 to an area on the outside of the cylindrical maintenance portion 40 (hereinafter properly called the “outside of the maintenance portion 40”). The second image forming portion 61 is provided on the outside of the maintenance portion 40. The second image forming portion 61 receives the exposure light from the first image forming portion 60 and irradiates the exposure light onto the substrate FB. The projection optical system PL projects the extended image of the pattern Pm onto the substrate FB in a state where the first image forming portion 60 has a projection magnification of same size or approximately same size and the second image forming portion 61 has an extended projection magnification (extension magnification).

The substrate guide device FST guides the substrate FB so that the substrate FB passes through a projection area PA onto which the image of the pattern Pm is projected by the projection device PU. The substrate guide device FST includes a guide portion 80, an upstream side roller 81, a downstream side roller 82, and a driving device ACF. The guide portion 80 is disposed on positions that correspond to the projection area PA of the projection optical system PL that is arranged on +X side of the maintenance portion 40 and the projection area PA of the projection optical system PL that is arranged on −X side.

The guide portion 80 has a support surface (support portion) 80a that supports the substrate FB. In the guide portion 80, an air bearing mechanism (not shown) is provided, and by this air bearing mechanism, the substrate FB can be supported in a non-contact manner on the support surface 80a. The support surface 80a is disposed on a position that is optically conjugate to the cylindrical surface 40a with respect to the projection optical system PL. The support surface 80a has a curved portion 83. The curved portion 83 is curved in a direction that optically corresponds to the curved. direction of the mask M by the projection optical system PL. Specifically, corresponding to the mask M that is curved and guided in the form of a concave cylindrical surface toward the projection optical system PL, the curved portion 83 is curved in the form of a convex cylindrical surface toward the projection optical system PL. The substrate FB that is guided by the guide portion 80 is curved after the fashion of the surface shape of the curved portion 83.

The position in which the curved portion 83 is disposed is not limited to the position that is optically conjugate to the above-described mask M (cylindrical surface 40a), but may be a position that is shifted from the position, for example, within the depth of focus of the image of the pattern Pm by the projection optical system PL. For example, the depth of focus δ is represented by

−k·λ/NA²≦δ≦+k·λ/NA²

Here, λ denotes the wavelength (center wavelength) of the exposure light ELI, NA denotes the number of openings on an image side of the projection optical system PL, and k denotes a process coefficient (coefficient that is determined on the basis of conditions to participate in image formation).

The curved portion 83 is curved with the same curvature (curvature radius) as the curvature of the mask M (curvature radius of the cylindrical surface 40a). Since the substrate FB is guided to be curved with the same curvature as the curvature of the mask M, the irradiation surface of the mask M onto which the exposure light ELI is irradiated and the irradiation surface of the substrate FB onto which the exposure light ELI is irradiated have the same curvature (curvature radius). In other words, the curvature (curvature radius) of the mask M that is positioned within the visual field area of the projection optical system PL becomes equal to the curvature (curvature radius) of the substrate FB that is positioned within the projection area (that is, the area onto which the pattern Pm within the visual field area is projected) of the projection optical system PL. Because of this, the mask M and the substrate FB satisfy the mutual conjugate relations within the visual field area of the projection optical system PL and through the entire surface in the projection area, and thus the extended image of the pattern Pm can be well projected onto the substrate FB through the entire surface in the projection area.

Second curved portions 84 are formed on the support surface 80a on the upstream side and the downstream side of the curved portion 83. The second curved portions 84 are provided in positions that correspond to an import portion and an export portion of the substrate FB in the guide portion 80. The second curved portion 84 is curved to have a larger curvature (that is, to have a smaller curvature radius) than the curved portion 83. Because of this, the substrate FB that is supported by the guide portion 80 avoids being in contact with the end portions of the upstream side and the downstream side of the guide portion 80, and is prevented from being damaged by the end portions. Further, when the front end portion of the substrate FB is imported onto the support surface 80a, it becomes possible to smoothly import the front end portion of the substrate FB without making the front end portion of the substrate FB in contact with the end portion on the upstream side of the guide portion 80.

In this embodiment, by providing the curved portion 83, the substrate FB that is guided by the guide portion 80 is curved and guided after the fashion of the surface shape of the curved portion 83. Accordingly, wrinkle or slack becomes hard to occur on the substrate FB on the support surface 80a (projection area) in comparison to a case where the substrate FB is guided in a plane shape. Through this, the precision of the alignment or focalization of the substrate FB can be improved. For example, tension of the size of the degree that growth does not occur is added to the substrate FB through control of, for example, the upstream side roller 81, the downstream side roller 82, and the driving device ACF, and thus the substrate FB can be set to make the substrate FB imitate the surface shape of the curved portion 83.

The upstream side roller 81 imports the substrate FB onto the guide portion 80. The downstream side roller 82 exports the substrate FB from the guide portion 80, For example, the upstream side roller 81 and the downstream side roller 82 transport the substrate FB at a predetermined transport speed. The driving device ACF adjusts the rotating speeds of the upstream side roller 81 and the downstream side roller 82.

The driving device ACF adjusts the rotating speeds of the upstream side roller 81 and the downstream side roller 82 based on a control signal from the control portion CONT, and through this, adjusts the transport speed of the substrate FB. The control portion CONT controls the driving of the driving device ACM and the driving of the driving device ACF so that the substrate FB is transported at the transport speed depending on the rotating speed of the mask M. Specifically, the control portion CONT controls the driving of the driving device ACM and the driving device ACF so that the ratio of the transport speed of the substrate FB in the length direction (that is, the moving speed of the surface of the substrate FB) to the moving speed (circumferential speed) of the mask M along the cylindrical surface 40a becomes equal to the projection magnification (extension magnification) of the projection optical system PL.

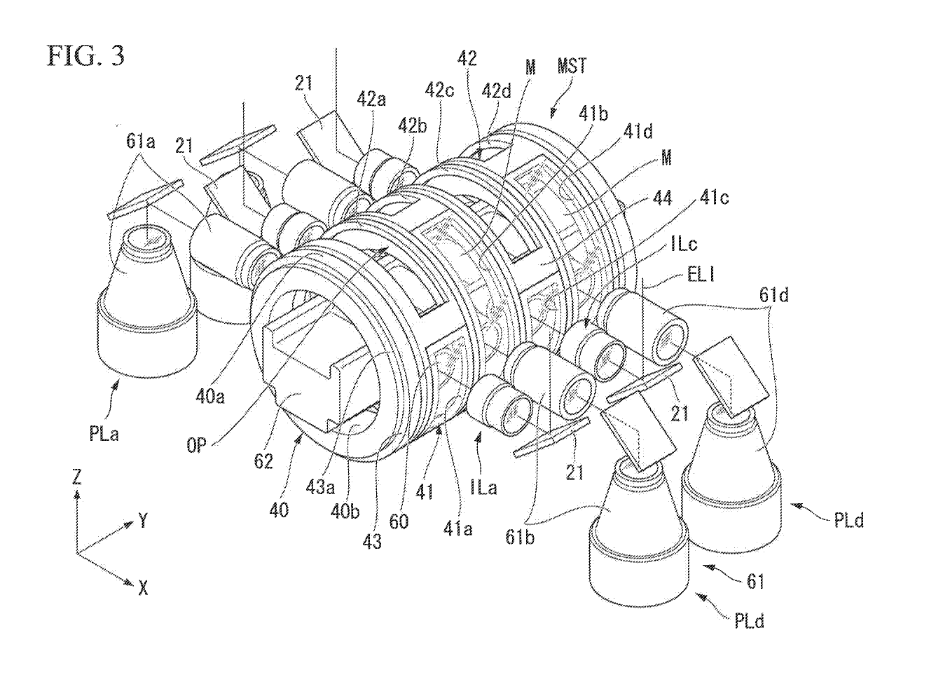

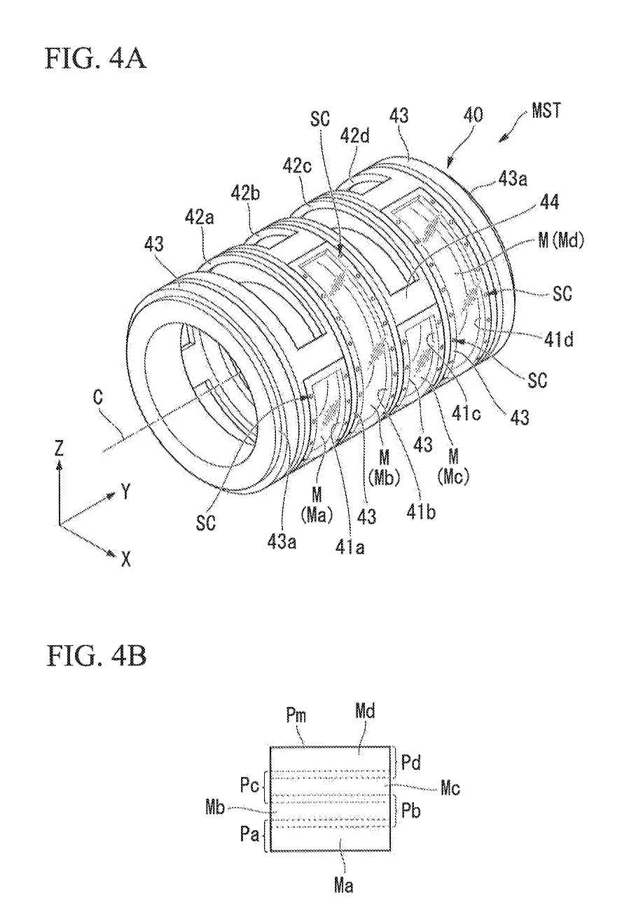

FIG. 3 is a perspective view illustrating the configuration of a mask moving device MST. FIG. 3 shows the state where a part of the projection device PU is deposited inside the maintenance portion 40. FIG. 4A is a perspective view illustrating the configuration of the maintenance portion 40, and FIG. 4B is a view illustrating the pattern Pm formed on the mask M.

As shown in FIGS. 2, 3, and 4A, the maintenance portion 40 of the mask moving device MST is formed along the cylindrical surface 40a. The maintenance portion 40 is rotatably provided along the circumferential direction of the cylindrical surface 40a around the axis line C, The maintenance portion 40 is detachably provided on the exposure apparatus EX by the fixing device (not shown) or the like.

The maintenance portion 40 is provided with ring portions 43 and connection portions 44. Five ring portions 43 are disposed around the axis line C as the common center axis. The connection portions 44 are disposed in positions in which the five ring portions 43 are connected. The connection portions 44 are provided to connect two adjacent portion ring portions 43 in two positions along the circumferential direction. The connection potions 44 in two positions are disposed in the positions that are symmetric on the basis of the axis line C (positions that face each other across the axis line C). Two connection portions 44 are provided in the circumferential direction in each of four positions among five ring portions 43, that is, eight connection portions 44 are provided in total, The number of ring portions 43 and connection portions 44 that constitute the maintenance portion 40 is not limited to the above-described number. In particular, the number of ring portions 43 corresponds to the number of projection optical systems.

The maintenance portion 40 has a plurality of openings OP that are formed by the ring portions 43 and the connection portions 44. The openings OP are formed to make the inner portion and the outer portion of the maintenance portion 40 communicate with each other. The plurality of openings OP include a first opening 41 and a second opening 42. The first opening 41 and the second opening 42 are formed so that the exposure light ELI can pass through the first opening 41 and the second opening 42.

The first opening portion 41 is provided in a position in which the mask M of the maintenance portion 40 is maintained. Four first openings 41 (first openings 41a to 41d) are provided along the axis line C. The maintenance portion 40 has mask adsorption portions SC in areas around the first openings 41a to 41d of the ring portions 43 and the connection portions 44.

The mask adsorption portion SC has an absorption port (not shown) provided on the ring portion 43 and the connection portion 44, and an absorption pump (no(shown) connected to the absorption port. The mask adsorption portion SC absorbs the mask M through the absorption port to make it possible to absorb the mask M in the maintenance portion 40. The mask adsorption portion SC may release the maintenance of the mask M through stopping the absorption of the mask M. By adjusting the absorption of the mask adsorption portion SC, the mounting and disassembling of the mask M can be smoothly shifted.

One sheet of masks M (Ma to Md) is kept for each of the first openings 41a to 41d. As shown in FIG. 4B, the masks Ma to Md have patterns Pa to Pd formed thereon so that a desired pattern Pm is formed as a whole in the case where the masks Ma to Md are mutually connected in a predetermined direction (direction corresponding to the axis C). In other words, by mutually connecting the patterns Pa to Pd formed on the masks Ma to Md in the predetermined direction, the pattern Pm is formed. Further, in areas of adjacent end portions (in FIG. 4B, mutually connected portions) of the mask Ma and Mb, the same pattern is formed. In the same manner, even in areas of the adjacent end portions of the masks Mb and Mc and the masks Mc and Md, the same pattern is formed.

Like the first openings 41a to 41d, four second openings 42 (second openings 42a to 42d) are provided along the axis line C. The second openings 42 are provided in positions that are symmetric with the first openings 41 (positions that face each other across the axis line C) on the basis of the axis line C. For example, the dimensions in the circumferential direction and the dimensions in the direction of the axis line C of the second openings 42a to 42d are the same as those of the first openings 41a to 41d. The first openings 41a to 41d and the second openings 42a to 42d are arranged to deviate from each other in the circumferential direction of the cylindrical surface 40a.

At both end portions in the direction of the axis line C of the maintenance portion 40, a connected portion 43a that is connected to a rotary mechanism (not shown) or the like is formed. The rotary mechanism is a part of the driving device ACM. The rotary mechanism may be, for example, a part of a gear mechanism that rotates the maintenance portion 40 or a moving object (a magnetic portion or a coil portion) of a linear motor mechanism.

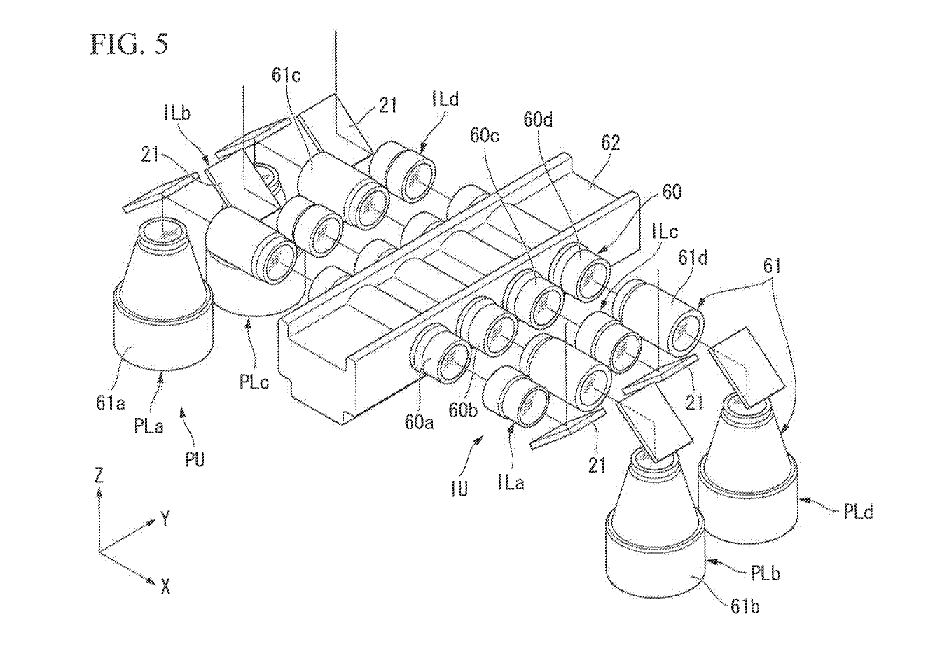

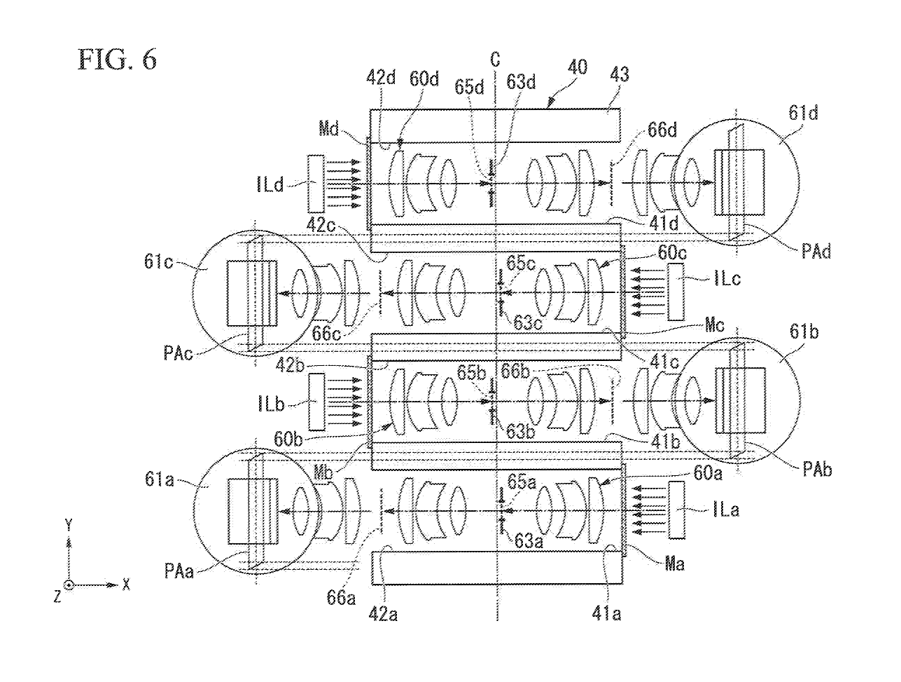

FIG. 5 is a view illustrating the partial configuration of an illumination device IU and a partial configuration of a projection device PU. FIG. 6 is a view schematically illustrating the configurations of an illumination device IU and a projection device PU.

As shown in FIGS. 3, 5, and 6, the illumination device IU has four illumination optical systems IL (illumination optical systems ILa to ILd) provided for every four masks M (Ma to Md) that are maintained in the maintenance portion 40. The illumination optical system ILa illuminates the mask Ma provided in the first opening 41a. The illumination optical system ILb illuminates the mask Mb provided in the first opening 41b. The illumination optical system ILc illuminates the mask Mc provided in the first opening 41c. The illumination optical system ILd illuminates the mask Md provided in the first opening 41d, Among them, the illumination optical systems ILa and ILb are disposed on +X side of the maintenance portion 40, and illuminate the masks Ma and Mc from the outside to the inside of the maintenance portion 40. Further, the illumination optical systems ILb and ILd are disposed on −X side of the maintenance portion 40, and illuminate the masks Mb and Md from the outside to the inside of the maintenance portion 40. The illumination optical systems ILa to ILd are disposed, for example, in the Y direction with pitches that correspond to the pitches (distances between adjacent centers) of the masks Ma to Md.

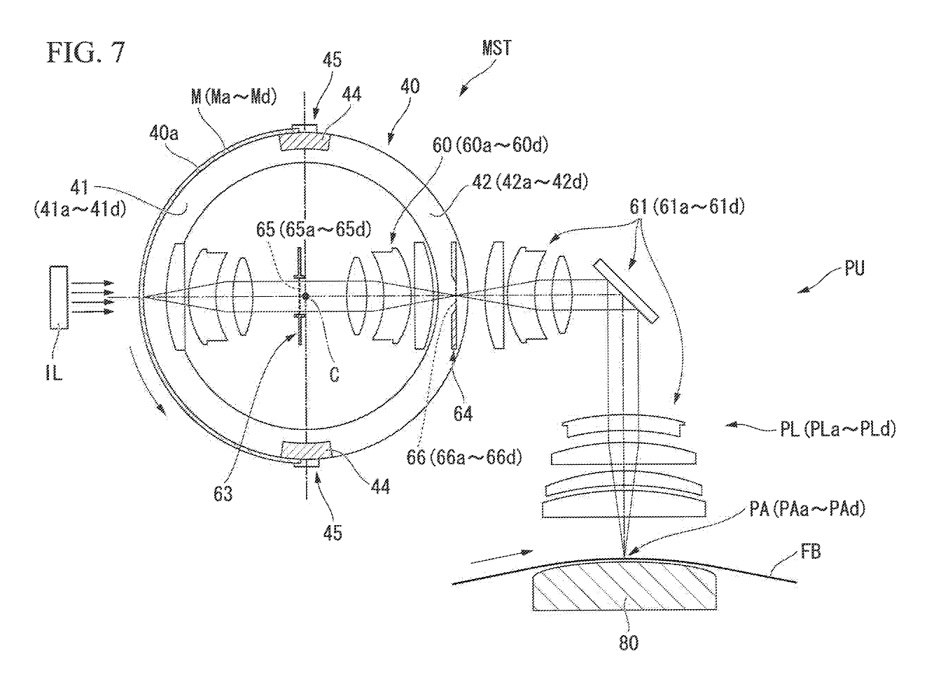

FIG. 7 is a view schematically illustrating the configuration of the projection device PU.

FIGS. 2,3, and 5 to 7, the projection device PU has four projection optical systems PL (PLa to PLd) that correspond to four illumination optical systems ILa to ILd and four masks Ma to Md. The projection optical system PLa is disposed on the illumination optical system ILa and the mask Ma, and the projection optical system PLb is disposed on the illumination optical system ILb and the mask Mb. The projection optical system PLc is disposed on the illumination optical system ILc and the mask Mc, and the projection optical system PLd is disposed on the illumination optical system ILd and the mask Md.

First image forming portions 60 (60a to 60d) of the projection optical systems PLa to PLd are disposed inside the respective maintenance portions 40. The first image forming portion 60a is disposed in a light path of the exposure light ELI through the mask Ma from the illumination optical system ILa. The first image forming portion 60b is disposed in a light path of the exposure light ELI through the mask Mb from the illumination optical system ILb. The first image forming portion 60c is disposed in a light path of the exposure light ELI through the mask Mc from the illumination optical system ILc. The first image forming portion 60d is disposed in a light path of the exposure light ELI through the mask Md from the illumination optical system ILd.

The first image forming portions 60a to 60d are maintained on a frame 62 (see FIG. 5). The frame 62 is disposed along the axis line C in the inside of the maintenance portion 40. The frame 62 and the first image forming 60a to 60d that are disposed inside the maintenance portion 40 are maintained in positions that do not make contact with the maintenance portion 40.

As shown in FIG. 6, the first image forming portions 60a to 60d guide the exposure light ELI from the respective illumination optical systems ILa to ILd through the masks Ma to Md and the first openings 41a to 41d to step over the axis line C in the inside of the maintenance portion 40, and emit the exposure light ELI to the outside of the maintenance portion 40 through the second openings 42a to 42d.

As shown in FIGS. 6 and 7, the first image forming portions 60 (60a to 60d) form pupil surfaces 65 (65a to 65d) in the inside of the maintenance portion 40. In this embodiment, the pupil surfaces 65a to 65d are formed in the neighborhood of the axis line C (for example, in the neighborhood of an incident surface side of the axis line C), On the pupil surfaces 65a to 65d, opening irises 63 (63a to 63d) are provided. Here, the pupil surface may include an incident pupil or an ejection pupil and a conjugate surface.

As shown in FIGS. 6 and 7, the first image forming portions 60 (60a to 60d) form intermediate images of the patterns Pm (Pa to Pd) in the neighborhood of the second openings 42 (42a to 42d). In this embodiment, the intermediate images 66 (66a to 66d) of the patterns Pm (Pa to Pd) are formed further to the inside of the maintenance portions 40 than the second openings 42 (42a to 42d). Further, in positions in which the intermediate image 66 (66a to 66d) are formed, blinds 64 (64a to 64d) that can be opened or closed are provided. The blinds 64a to 64d are controlled to be opened or closed by the control portion CONT.

On the other hand, the second image forming portions 61 (61a to 61d) of the projection optical systems PLa to PLd are disposed outside the maintenance portions 40. The second image forming portions 61a to 61d receive the exposure light ELI emitted from the first image forming portions 60a to 60d, and project extended images of the intermediate images 66a to 66d, and further, extended images of the patterns Pa to Pd, onto predetermined projection areas PA a to PAd. Here, the projection areas PAa and PAc are provided further to the −X side than the maintenance portion 40, and the projection areas PAb and PAd are provided further to the +X side than the maintenance portion 40. The guide portion 80 that is further to the −X side than the maintenance portion 40 is disposed on lower portions of the projection areas PAa and PAc, and the guide portion 80 that is further to the +X side than the maintenance portion 40 is disposed on lower portions of the projection areas PAb and PAd.

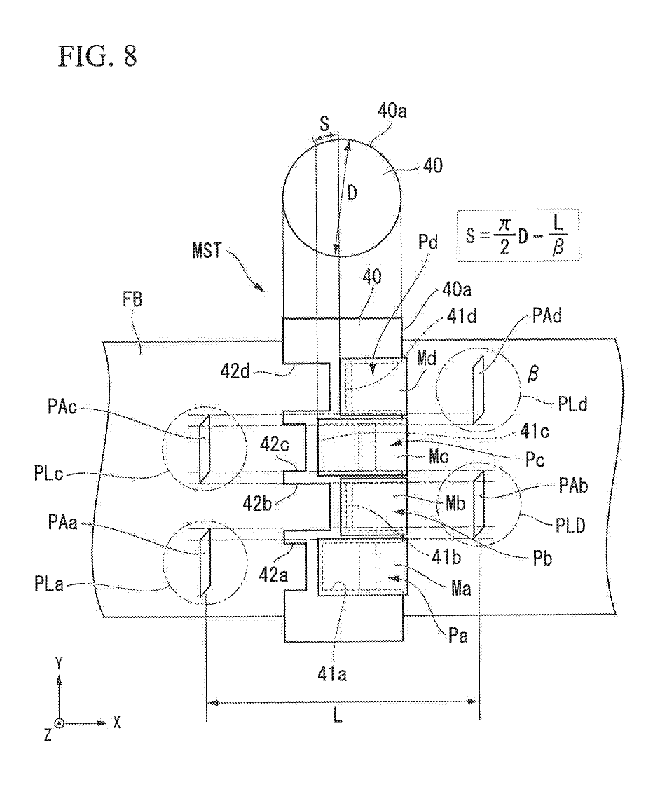

FIG. 8 is a plan view illustrating the positional relations between the mask moving device MST and the substrate FB.

As shown in FIG. 8, the projection areas PAa to PAd by the projection optical systems PLa to PLd, for example, are formed in a shape that two sides are parallel along the Y direction (in this embodiment, in a parallelogram shape). The projection areas PAa to PAd are formed so that the width (dimensions in X direction) of the end portions in the Y direction becomes gradually small. Hereinafter, the portion in which the width thereof becomes gradually small is written as a taper portion. The shape of the projection areas PAa to PAd is not limited to the parallelogram shape, but may be a trapezoidal shape or a hexagonal shape having a taper portion at the end portion in the Y direction. The shapes of the projection areas PAa to PAd are set by the respective blinds 64a to 64d.

The projection optical system PLa and the projection optical system PLb are disposed so that the position about the Y direction of the taper portion that is formed on +Y side of the projection area PAa overlaps the position about the Y direction of the taper portion that is formed on the −Y side of the projection area PAb. The projection optical system PLb and the projection optical system PLc are disposed so that the position about the Y direction of the taper portion that is formed on the +Y side of the projection area PAb overlaps the position about the Y direction of the taper portion that is formed on the −Y side of the projection area PAc. Further, the projection optical system PLc and the projection optical system PLd are disposed so that the position about the Y direction of the taper portion that is formed on +Y side of the projection area PAc overlaps the position about the Y direction of the taper portion that is formed on the −Y side of the projection area PAd.

In a part of FIG. 8, a schematic view when the maintenance portion 40 is viewed in +Y direction is shown. Here, if it is assumed that a mutual shifted amount in the circumferential direction of two first adjacent openings along the direction of the axis line C of the first openings 41a to 41d (a mutual shifted amount in the circumferential direction of the patterns of the masks M that are provided on the two first adjacent openings in the direction of the axis line C) is S, a diameter D of the maintenance portion 40 (cylindrical surface 40a) is D, a pitch in the X-axis direction between the projection optical systems PLa and PLc (first projection optical systems) and the projection optical systems PLb and PLd (second projection optical systems) (in general, pitch depending on moving paths of the substrate FB) is L, and a projection magnification of the projection optical systems PLa to PLd is β, the shifted amount S is set to satisfy the following equation.

S=π×D/2−L/β(however, L≦β×π×D/2).

In this embodiment, the irradiation optical system 21 that corresponds to the first projection optical system and the irradiation optical system 21 that corresponds to the second projection optical system irradiate the exposure light ELI onto the mask M from the directions that face each other, and thus the visual field area of the first projection optical system and the visual field area of the second projection optical system are positioned on the opposite sides of the mask M across the axis line C. However, the invention is not limited to such a configuration. In response to this, the shifted amount S is set by the following equation using a pitch (distance between centers) N from the visual held area of the first projection optical system according to the circumferential direction of the cylindrical surface 40a to the visual field area of the second projection optical system with respect to the rotary proceeding direction of the mask M, a pitch L, and a projection magnification β.

S=N−L/β(however, L≦β×N)

Further, using a center angle φ (radian) of an arc of the cylindrical surface 40a that corresponds to the pitch N, the shifted amount S can be set by the following equation.

S=φ×D/2−L/β

Further, in other words, the pitch N may be a pitch from the visual field area of the projection optical system that forms the projection area on the downstream side of the substrate FB to the visual field area of the projection optical system that forms the projection area on the upstream side of the substrate FB according to the circumferential direction of the cylindrical surface 40a with respect to the rotary proceeding direction of the mask M.

The substrate processing device FPA as configured above manufactures a display element (electronic device) such as an organic EL element and a liquid crystal display element by a roll method under the control of the control portion CONT. Hereinafter, a process of manufacturing a display element using the substrate processing device FPA as configured above will be described.

First, a belt-shaped substrate FB that is wound on a roller (not shown) is mounted on the substrate supply unit SU. The control portion CONT rotates the roller (not shown) so that the substrate FB is sent out from the substrate supply unit SU in this state. Further, the control portion CONT winds the substrate FB having passed through the substrate processing portion PR on the roller (not shown) provided in the substrate recovery portion CL. By controlling the substrate supply portion SU and the substrate recovery portion CL, it becomes possible to continuously transport a surface Fp to be processed of the substrate FB with respect to the substrate processing portion PR.

The control potion CONT sequentially forms constituent elements of the display element on the substrate FB through the processing device 10 while properly transporting the substrate FB in the substrate processing portion PR through the transport device 30 of the substrate processing portion PR in the interval until the substrate FB is wound by the substrate recovery portion CL after the substrate FB is sent out from the substrate supply portion SU. If the process is performed by the exposure apparatus EX during this process, masks Ma to Md are first mounted on the maintenance portion 40.

Next, the control portion CONT makes the exposure light ELI from the illumination device IU irradiated onto the pattern Pm of the mask M. The projection optical system projects the extended image of the pattern Pm onto the projection areas PAa to PAd.

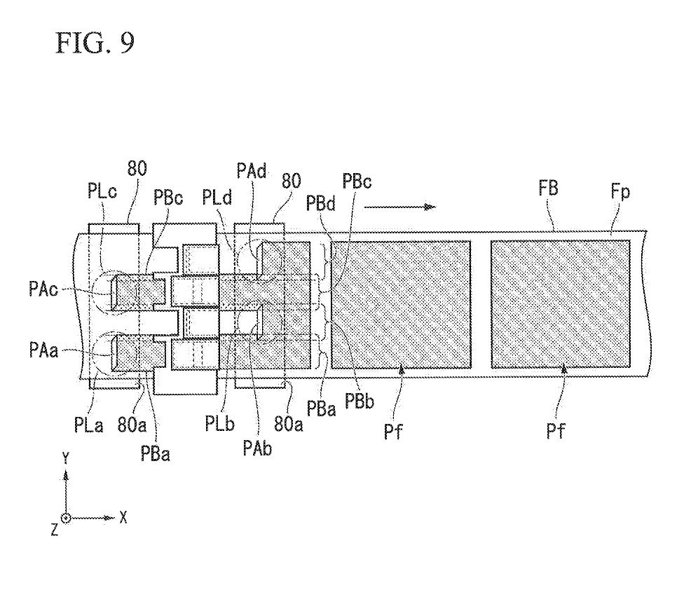

As shown in FIG. 9, the projection areas PAa to PAd are formed on the area that is disposed on the curved portion 83 of the guide portion 80 of the substrate FB. The corresponding portion of the substrate FB is curved after the fashion of the curved portion 83. The projection areas PAa to PAd are formed on the curved substrate FB.

The control portion CONT first performs the exposure process on the upstream side (−X side) of the maintenance portion 40. The control portion CONT makes the exposure light ELI from the illumination optical systems ILa and ILc irradiated onto the patterns Pa and Pc of the masks Ma and Mc. The exposure light ELI passes through the masks Ma and Mc and the first openings 41a and 41c in order, and is incident to the first image forming portions 60a and 60c of the projection optical systems PLa and PLc inside the maintenance portion 40.

The exposure light ELI through the first image forming portions 60a and 60c passes through the second openings 42a and 42c, and is incident to the second image forming units 61a and 61c. The exposure light ELI through the second image forming portions 61a and 61c is irradiated onto the projection areas PAa and PAc. By this operation, an extended image of the pattern Pa and an extended image of the pattern Pc are projected onto the projection areas PAa and PAc, respectively. In this state, the control portion CONT moves the substrate FE in +X direction while rotating the maintenance portion 40 through the driving device ACM. Through this, two areas of the substrate FB which are apart from each other in the Y direction are exposed in order from +X side to −X side by the extended images of the patterns Pa and Pc which are projected onto the projection areas PAa and PAc, and the belt-shaped exposure areas PBa and PBc are formed on the substrate FB in the X-axis direction. At this time, the control portion CONT adjusts the rotating speed of the maintenance portion 40 and the moving speed of the substrate FB so that the ratio of the moving speed in the length direction of the substrate FB to the moving speed of the mask M according to the cylindrical surface 40a becomes equal to the projection magnification (extension magnification) of the projection optical system PL, and makes the driving device ACM and the driving device ACF perform the corresponding operations.

Continuously, if the +X side end portions of the exposure areas PBa and PBc reach the X-direction positions that are equal to the projection areas PAb and Pad according to the movement of the substrate FB, the control portion CONT then performs the exposure process on the downstream side (±X side) of the maintenance portion 40. The control portion CONT makes the exposure light ELI from the illumination optical systems ILb and ILd irradiated onto the patterns Pb and Pd of the masks Mb and Md, respectively.

The exposure light ELI through the patterns Pb and Pd passes through the first openings 41b and 41d, the first image forming portions 60b and 60d, and the second openings 42b and 42d in order, and is incident to the second image forming portions 61b and 61d. The exposure light ELI through the second image forming portions 61b and 61d are irradiated onto the projection areas PAb and PAd.

Onto the projection areas PAb and PAd, extended images of the patterns Pb and Pd are projected. Through this, two areas of the substrate FB which are apart from each other in the Y direction are exposed in order from the +X side to the −X side by the extended images of the patterns Pb and Pd that are projected onto the projection areas PAb and Pad, and the belt-shaped exposure areas PBb and PBd in the X-axis direction are formed on the substrate FB. At this time, the end portion on the −Y side and the end portion on the +Y side of the exposure area PBb are exposed in a state where they overlap the end portion on the +Y side of the exposure area PBa and the end portion on the −Y side of the exposure area PBc, and the end portion on the −Y side of the exposure area PBd is exposed in the state where it overlaps the end portion on the +Y side of the exposure area PBc. Continuously, the control portion CONT controls the driving device ACM and the driving device ACF to adjust the rotating speed of the maintenance portion 40 and the moving speed of the substrate FB so that the moving speed in the length direction of the substrate FB to the moving speed of the mask M according to the cylindrical surface 40a becomes equal to the projection magnification of the projection optical system PL.

In this embodiment, on the substrate FB, a portion which is exposed only by a single independent image that is projected onto the projection areas PAa to PAd, a portion which is exposed by a part of an image that is projected onto the projection area PAa and a part of an image that is projected onto the projection area PAb, a portion which is exposed by a part of an image that is projected onto the projection area PAb and a part of an image that is projected onto the projection area PAc, and a portion which is exposed by a part of an image that is projected onto the projection area PAc and a part of an image that is projected onto the projection area PAd are formed. As described above, by performing the exposure operation, an exposure pattern Pf that corresponds to the extended image of the pattern Pm shown in FIG. 4B is formed on the substrate FB.

As described above, according to this embodiment, as the mask moving device MST that maintains and moves the mask M having the pattern Pm, the maintenance portion 40 that is formed in a cylindrical shape is provided to detachably maintain the mask M along the cylindrical surface 40a so that the pattern Pm is deposited on the cylindrical surface 40a. Accordingly, the image of the pattern Pm can efficiently be exposed on the belt-shaped substrate FB. Through this, the moving device MST capable of efficiently manufacturing the display element on the belt-shaped substrate FB can be provided.

According to this embodiment, since the exposure light through the mask M is formed to pass through the inside of the maintenance portion 40, a space inside the maintenance portion 40 can be effectively used. Through this, space saving of the exposure apparatus EX can be sought. Further, since the driving device ACM that rotates the maintenance portion 40 along the circumferential direction of the cylindrical surface rotates the maintenance portion 40 through the end portion in the direction of the axis line C of the maintenance portion 40, the maintenance portion 40 can be rotated without intercepting the exposure light that passes through the inside of the maintenance portion 40.

The technical range of the invention is not limited to the above embodiment, but may be appropriately changed without departing from the scope of the invention.

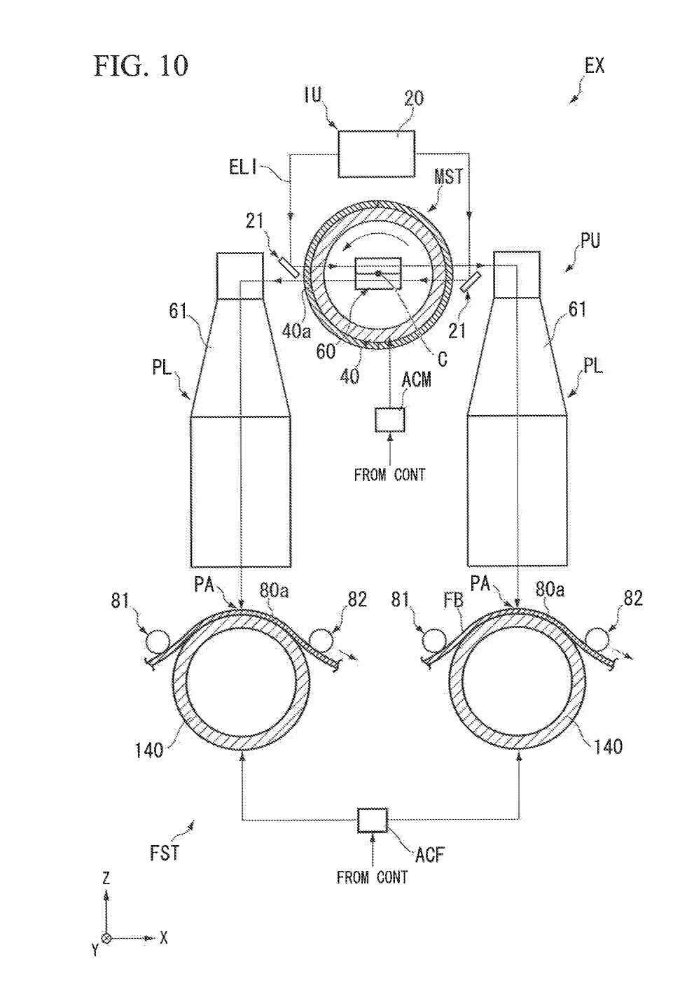

For example, in the above-described embodiment, the substrate guide device FST that guides the substrate FB is configured to use the guide portion 80 that supports the substrate FB. However, the configuration of the substrate guide device FST is not limited thereto. For example, as shown in FIG. 10, the configuration that uses guide rollers 140 having a cylindrical surface having the same diameter as the cylindrical surface 40a of the maintenance portion 40 may be used.

In this case, when rotating the maintenance portion 40 and the guide rollers 140, the control portion CONT controls the driving device ACM of the maintenance portion 40 and the driving device (roller driving portion) AFC of the guide roller 140 in synchronization with each other. Specifically, the control portion CONT controls the driving of the driving device ACM and the driving device ACF so that the ratio of the moving speed of the substrate FB according to the surface of the guide roller 140 to the moving speed of the mask M according to the cylindrical surface 40a becomes equal to the projection magnification (extension magnification) of the projection optical system PL.

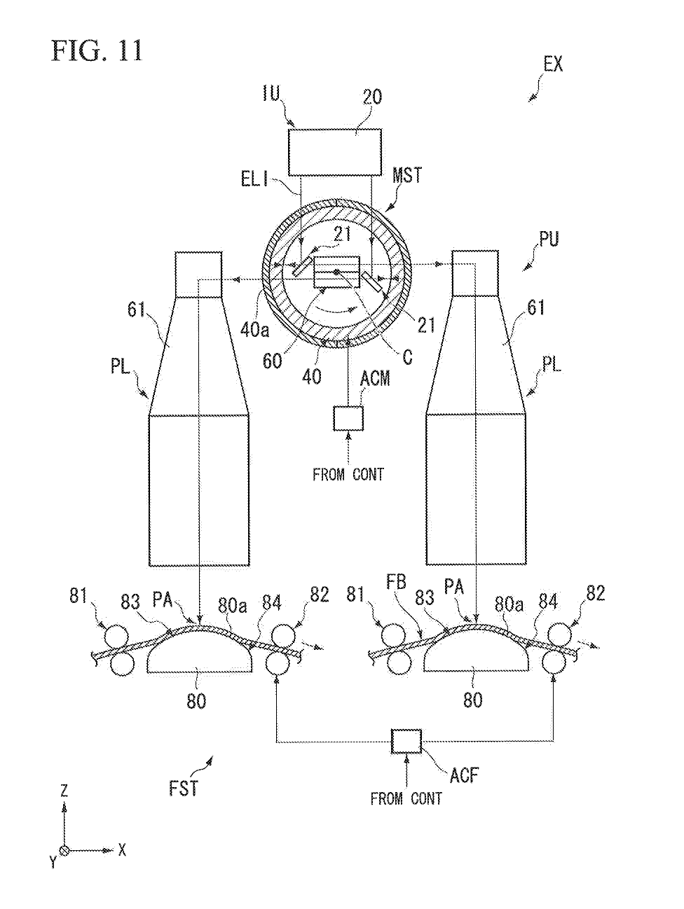

In the embodiment, it is configured that the illumination device IU is deposited on the outside of the mask moving device MST (maintenance portion 40), and the exposure light ELI which is from the outside of the maintenance portion 40 and is transmitted through the mask M that is a transmission mask is incident to the inside of the maintenance portion 40. However, the invention is not limited to the above-described configuration. For example, as shown in FIG. 11, by using a reflection type mask as the mask M, introducing the exposure light ELI that is from the illumination device through the end portion in the direction of the axis line C of the maintenance portion 40 to the inside of the maintenance portion 40, and reflecting the exposure light ELI from the mask M in the inside of the maintenance portion 40, the exposure light ELI may pass through the inside of the maintenance portion 40.

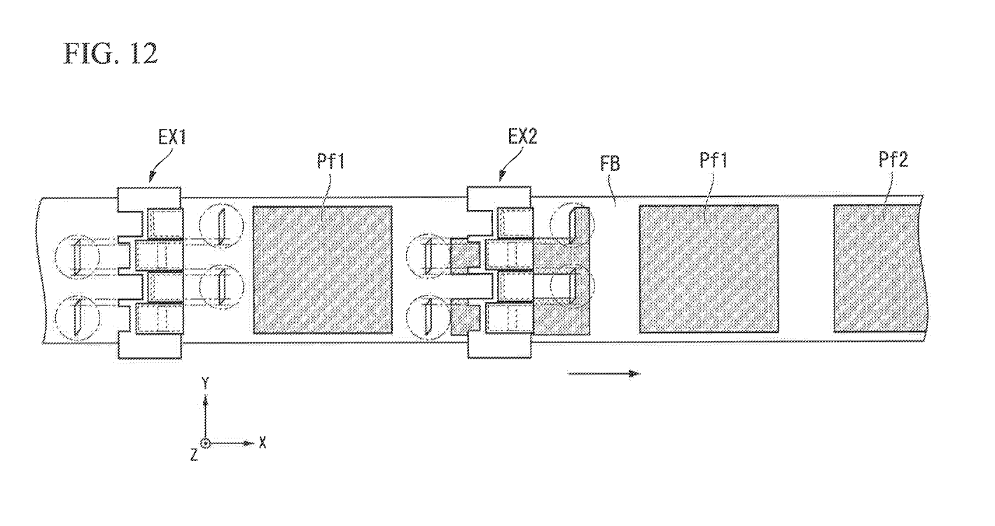

The configuration of the substrate processing device FPA using one exposure apparatus EX is an exemplary example of the embodiment. However, the invention is not limited to this. For example, as shown in FIG. 12, a plurality of (for example, two) exposure apparatuses EX may be configured. In this case, on the substrate FB, an exposure pattern Pf1 by a first exposure apparatus EX1 and an exposure pattern Pf2 by a second exposure apparatus EX2 are formed.

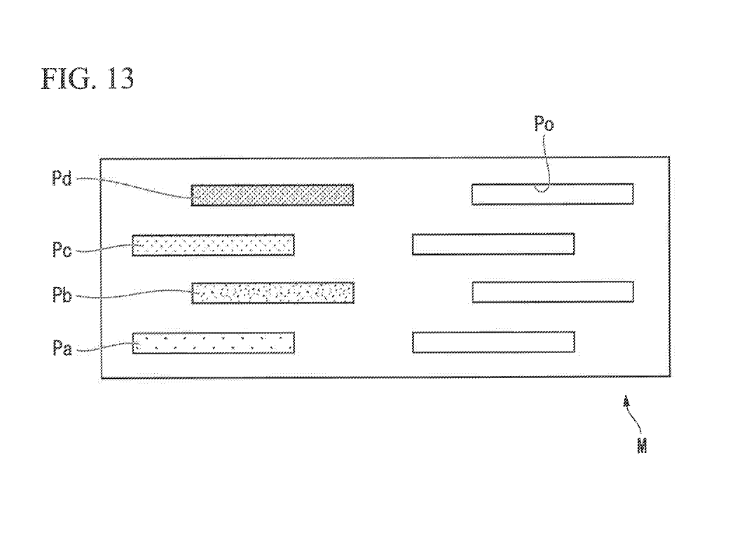

In the embodiment, four masks M are maintained in the maintenance portion 40. However, the invention is not limited thereto, and for example, as shown in FIG. 13, one mask M on which four patterns Pa to Pd are formed may be configured to be maintained in the maintenance portion 40. In this case, the patterns Pa to Pd are formed in positions that correspond to the first openings 41a to 41d of the maintenance portion 40, and an opening Po is formed in a position that corresponds to the second openings 42a to 42d. Through this configuration, the mounting, disassembling, and exchanging of the mask M can be easily performed.

In the embodiment, a first opening portion 41 and a second opening portion 42 are formed in the circumferential direction of the maintenance portion 40. However, the invention is not limited thereto. For example, as shown in FIG. 14, three first openings 141 and three second openings 142 may be formed in the circumferential direction of the maintenance portion 40, and masks M1, M2, and M3 that correspond to the first openings 141 may be formed. Further, two or four or more first openings 141 and two or four or more second openings 142 may be formed in the circumferential direction of the maintenance portion 40.

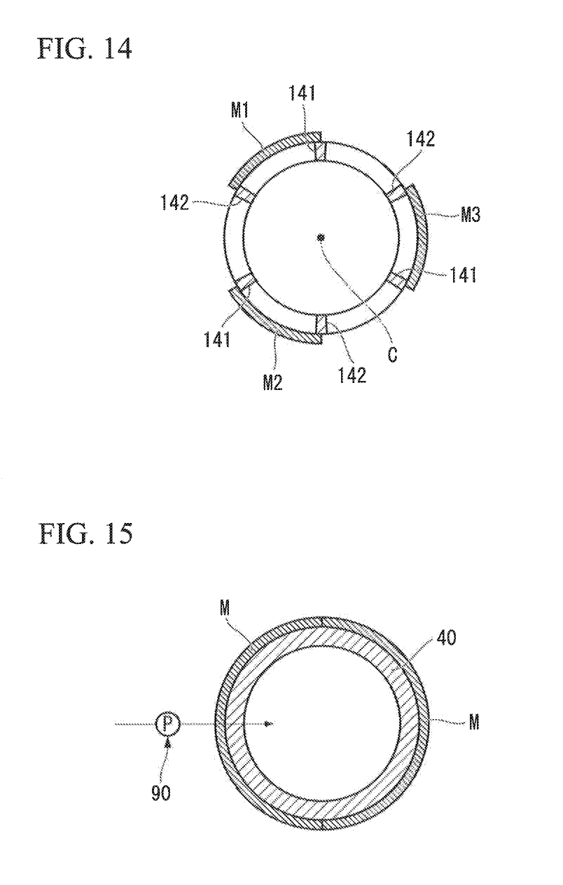

In the embodiment, when the mask M is maintained in the maintenance portion 40, the mask M is curved so that the periphery of the mask M complies with the shape of the ring portion 43 of the maintenance portion 40. However, the present invention is not limited thereto. For example, as shown in FIG. 15, gas may be supplied to the inside of the maintenance portion 40 using a gas supply pump 90 or the like, and the curve of the mask M may be adjusted using the pressure of the inside of the maintenance portion 40.

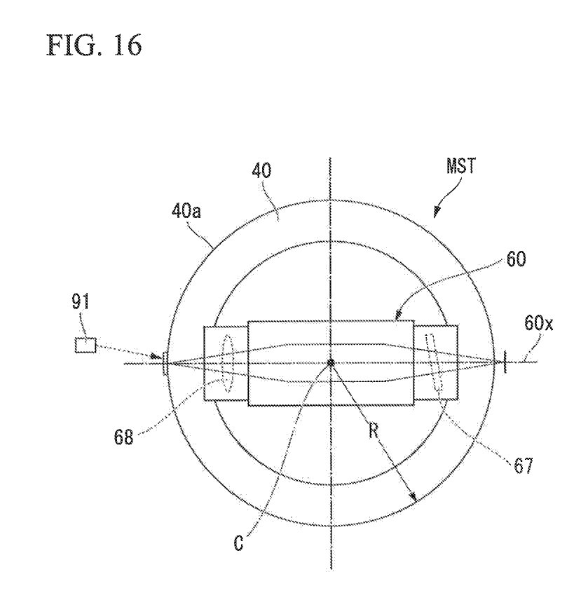

In addition to the configuration according to the embodiment, for example, as shown in FIG. 16, a sensor (detection unit) 91 for detecting position information (for example, coordinates or the like in X Y, and Z directions) about a predetermined position on the cylindrical surface 40a of the maintenance portion 40 arranged in a rotary position may be provided. According to this configuration, by detecting the change of the position coordinates of the cylindrical surface 40a, the eccentric rotation of the maintenance portion 40 can be detected. Further, the sensor 91 may be configured to detect the position information of the predetermined position of the mask NI instead of the position information of a fixed position of the cylindrical surface 40a.

Further, an adjustment portion, for example, adjusting an image forming position of the exposure light ELI depending on the result of the detection by the sensor 91 may be provided. As such a configuration, for example, as shown in FIG. 16, parallel monotonous glass 67 or a focus adjustment lens 68 may be provided as a part of the first image forming portion 60 or separately from the first image forming portion 60. In this case, the parallel monotonous glass 67 may be inclinable with respect to the optical axis 60x of the first image forming unit 60, and the focus adjustment lens 68 may be movable (position variable) along the optical axis 60x. Further, it is preferable that the parallel monotonous glass 67 cross the optical axis 60x and be inclinable (rotatable) around the axis that is parallel to the axis line C of the cylindrical surface 40a.

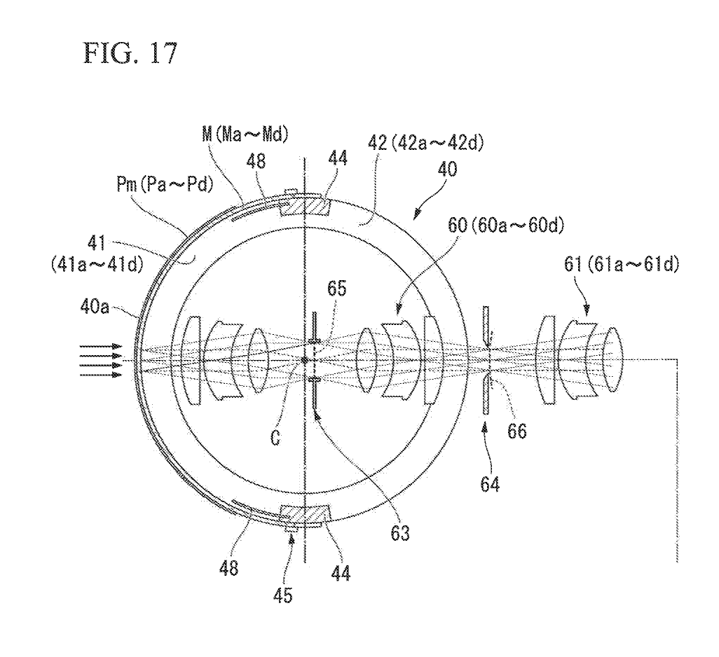

In the embodiment, it is configured that the first image forming portion 60 forms the pupil surface 65 that is further to the upstream side of the light path than the axis line C of the maintenance portion 40 and forms the intermediate image 66 of the pattern Pm in the inside of the maintenance portion 40. However, the invention is not limited thereto. For example, as shown in FIG. 17, the pupil surface 65 may be formed further to the downstream side of the light path than the axis line C of the maintenance portion 40. Further, the intermediate image 66 of the pattern Pm may be formed on the outside of the maintenance portion 40. Further, the pupil surface 65 may be formed on the outside of the maintenance portion 40.

In addition to the configuration according to the above-described embodiment, as shown in FIG. 17, for example, blinds 48 may be provided in the first openings 41. Further, for example, a clamp mechanism 45 to hold across the mask M may be deposited. The clamp mechanism 45 may be deposited, for example, on the connection portion 44 of the maintenance portion 40. Of course, the clamp mechanism 45 may also be provided on the ring portion 43 of the maintenance portion 40.

Further, in the configuration of FIG. 17, the second image forming portion 61 may be omitted to project the image of the pattern Pm onto the substrate.

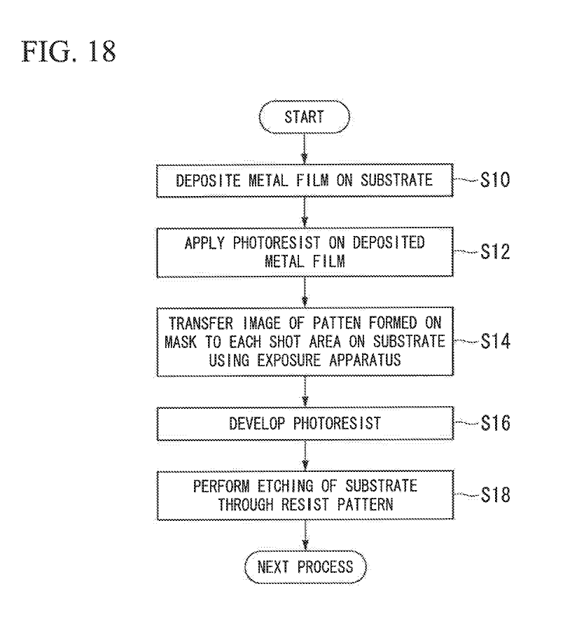

Next, a method of manufacturing a micro device in which the exposure apparatus according to an embodiment of the invention is used in a lithography process will be described. FIG. 18 is a flowchart illustrating a part of a manufacturing process when a semiconductor device is manufactured as a micro device. First in step S10 of FIG. 18, a metal film is deposited on a belt-shaped substrate. In the next step S12, a photoresist is applied on the metal film deposited on the substrate. Thereafter, in step S14, using the exposure apparatus EX, images of the patterns on the mask M are sequentially exposed and transferred to respective shot areas of the substrate (transfer process) through the projection devices PU (projection optical systems PL1 to PL4).

Thereafter, in step S16, development (development process) of the photoresist of the substrate is performed, and then, in step S18, by performing etching of the substrate through the resist pattern, circuit patterns that correspond to the patterns on the mask are formed in the respective shot areas of the substrate. Thereafter, by forming a circuit pattern of a further upper layer, a device such as a semiconductor device is manufactured. According to the above-described method of manufacturing a semiconductor device, a semiconductor device having an extremely minute circuit pattern can be efficiently manufactured with good throughput.

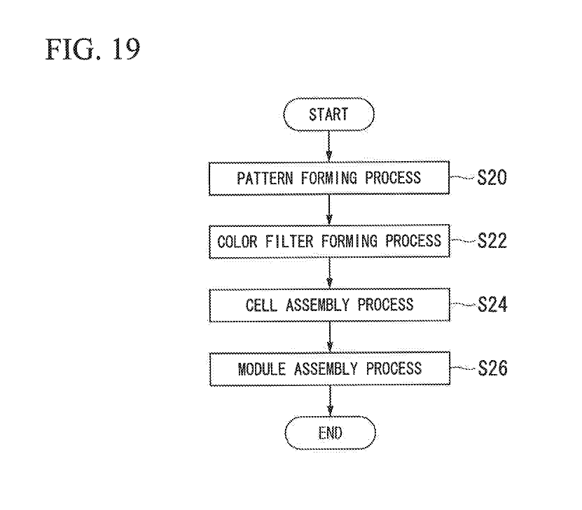

Further, in the exposure apparatus EX, by forming the predetermined patterns (circuit patterns, electrode patterns, and the like) on the belt-shaped substrate, a liquid crystal display element as the micro device can be manufactured. Hereinafter, with reference to a flowchart of FIG. 19, an example of the technique at that time will be described. FIG. 19 is a flowchart illustrating a part of a manufacturing process when a liquid crystal display element is manufactured as a micro device.

In a pattern forming process S20 of FIG. 19, a so-called light lithography process for transferring and exposing the pattern of the mask M to the photosensitive substrate (for example, glass or plastic substrate on which the resist is applied) using the exposure apparatus EX according to this embodiment is performed. By this light lithography process, a predetermined pattern that includes a plurality of electrodes is formed on the photosensitive substrate. Thereafter, the exposed substrate passes through respective processes, such as a development process, an etching process, a reticule detachment process, and the like, to form the predetermined pattern on the substrate, and then the next color filter forming process S22 is performed.

Next, in the color filter forming process S22, a color filter in which multiple groups of three dots that correspond to R (Red), G (Green), and B (Blue) are arranged in the form of a matrix or groups of filters of three stripes of R, G, and B are arranged in a direction of a plurality of horizontal scanning lines. After the color filter forming process S22, a cell assembly process S24 is performed. In the cell assembly process S24, a liquid crystal panel (liquid crystal cells) is assembled using the substrate having the predetermined pattern obtained in the pattern forming process S20 and the color filter obtained in the color filter forming process S22.

In the cell assembly process S24, for example, liquid crystals are injected. between the substrate having the predetermined pattern obtained in the pattern forming process S20 and the color filter obtained in the color filter forming process S22 to manufacture the liquid crystal panel (liquid crystal cells). Thereafter, in a module assembly process S26, respective components, such as an electric circuit, backlight, and the like, for performing the display operation of the assembled liquid crystal panel (liquid crystal cells) are installed to complete the liquid crystal display element. According to the above-described method of manufacturing the liquid crystal display element, the liquid crystal display element having extremely minute circuit patterns can efficiently be manufactured with good throughput.

### REFERENCE SIGNS LIST

EX: EXPOSURE APPARATUS

M: MASK

Pm: PATTERN

IU: ILLUMINATION DEVICE

MST: MASK MOVEMENT DEVICE

PU: PROJECTION DEVICE

FST: SUBSTRATE GUIDE DEVICE

ELI: EXPOSURE LIGHT

ACM, ACF: DRIVING DEVICE

PL: PROJECTION OPTICAL SYSTEM

PA: PROJECTION AREA

FPA: SUBSTRATE PROCESSING APPARATUS

FB: SUBSTRATE

SU: SUBSTRATE SUPPLY PORTION

PR: SUBSTRATE PROCESSING PORTION

CL: SUBSTRATE RECOVERY PORTION

CONT: CONTROL PORTION

1-20. (canceled)

21. An exposure apparatus which transfers a pattern that is provided along a predetermined cylindrical surface onto a substrate while rotating the pattern in a circumferential direction of the cylindrical surface, comprising:
a first projection optical system that projects an image of a first partial pattern of the pattern which is disposed in a first area of the cylindrical surface onto a first projection area;
a second projection optical system that projects an image of a second partial pattern of the pattern which is disposed in a second area different from the first area onto a second projection area different from the first projection area; and
a guide device that guides the substrate to the first projection area and the second projection area in synchronization with a rotation of the pattern in the circumferential direction.

22. The exposure apparatus according to claim 21, wherein the first partial pattern and the second partial pattern are provided at a predetermined interval along a central axis of the cylindrical surface and mutually are shifted for a predetermined amount in the circumferential direction of the cylindrical surface, and
a pitch N from the first area to the second area along the circumferential direction of the cylindrical surface with respect to a rotary proceeding direction of the pattern, a pitch L from the first projection area to the second projection area along a movement path of the substrate by the guide device, a projection magnification β of the first projection optical system and the second projection optical system, and the predetermined amount S satisfy relations of S=N−L/β and L≦β×N.

23. The exposure apparatus according to claim 21, wherein the first partial pattern and the second partial pattern are provided at predetermined intervals along a central axis of the cylindrical surface and mutually are shifted for a predetermined amount in the circumferential direction of the cylindrical surface, and
a diameter D of the cylindrical surface, a pitch L from the first projection area to the second projection area along a movement path of the substrate by the guide device, a projection magnification β of the first projection optical system and the second projection optical system, and the predetermined amount S satisfy relations of S=π×D/2−Lβ and L≦β×π×D/2.

24. The exposure apparatus according to claim 22, wherein the predetermined interval is set so that an end position of the first projection area and an end position of the second projection area at least partially overlap each other on the movement path of the substrate by the first projection optical system and the second projection optical system.

25. The exposure apparatus according to claim 21, wherein the guide device includes a first support portion and a second support portion that support the substrate that is positioned in the first projection area and the second projection area.

26. The exposure apparatus according to claim 25, wherein the first support portion and the second support portion have a first curved portion and a second curved portion which are curved in an optically corresponding direction with respect to a curved direction of the cylindrical surface by the first projection optical system and the second projection optical system, respectively, and support the substrate through curving the substrate along the first and second curved portions.

27. The exposure apparatus according to claim 26, wherein the first curved portion and the second curved portion are curved in a convex shape toward the first projection optical system and the second projection optical system.

28. The exposure apparatus according to claim 26, wherein the first curved portion and the second curved portion are curved in the same curvature as the cylindrical surface.

29. The exposure apparatus according to claim 26, wherein the first support portion and the second support portion include a guide roller that guides the substrate along surfaces thereof and a roller driving portion that rotates the guide roller along the circumferential direction of the surface, and
the first curved portion and the second curved portion are provided on surface portions of the corresponding guide roller.

30. The exposure apparatus according to claim 29, wherein the roller driving portion rotates the guide roller in synchronization with the rotation of the pattern.

31. The exposure apparatus according to claim 21, wherein the first projection optical system or the second projection optical system includes:
a first optical system that is disposed inside the cylindrical surface and emits light from the pattern to an outside of the cylindrical surface; and
a second optical system that projects an image of the pattern by irradiating the light through the first optical system to the first projection area or the second projection area.

32. The exposure apparatus according to claim 31, wherein the first optical system forms an intermediate image of the pattern in the neighborhood of the cylindrical surface.

33. The exposure apparatus according to claim 32, wherein the first optical system includes an adjustment portion that adjusts an image forming position of the intermediate image.

34. The exposure apparatus according to claim 33, further comprising a detection portion that detects position information of the pattern,
wherein the adjustment portion adjusts the image forming position of the intermediate image based on the result of the detection by the detection portion.

35. The exposure apparatus according to claim 21, wherein the first projection optical system and the second projection optical system form a pupil surface of the first projection optical system and a pupil surface of the second projection optical system in the neighborhood of the cylindrical surface.

36. An exposure apparatus which transfers a pattern that is provided along a predetermined cylindrical surface onto a substrate while rotating the pattern in a circumferential direction of the cylindrical surface, comprising:
a projection optical system that projects an image of the pattern onto a projection area; and
a guide device that guides the substrate to the projection area in synchronization with a rotation of the pattern in the circumferential direction, and has a curved portion which supports the substrate through curving the substrate that is positioned in the projection area.

37. The exposure apparatus according to claim 36, wherein the curved portion is curved in a convex shape toward the projection optical system.

38. The exposure apparatus according to claim 36, wherein the curved portion is curved in the same radius of curvature as the cylindrical surface.

39. A substrate processing apparatus which processes a belt-shaped substrate, comprising:
a substrate transport portion that transports the substrate in a length direction of the substrate; and
a substrate processing portion that is provided along a transport path of the substrate by the substrate transport portion and performs processing of the substrate that is transported along the transport path,
wherein the substrate processing portion includes the exposure apparatus according to claim 21 that transfers the pattern onto the substrate.

40. A device manufacturing method for manufacturing a device through processing of a substrate, comprising:
transferring a pattern onto the substrate using the exposure apparatus according to claim 21; and
processing the substrate onto which the pattern has been transferred on the basis of the pattern.

41. An exposure method for exposing a device pattern onto a flexible substrate, the exposure method comprising:
rotating a hollow cylindrical mask, in which a mask pattern corresponding to the device pattern is partially formed along a circumferential surface separated from a predetermined axis line at a definite radius, about the predetermined axis line;
irradiating the cylindrical mask with an illumination light from an illumination system so that a patterned light for exposure generated from the mask pattern of the cylindrical mask passes through an inside of the cylindrical mask toward an outside thereof;
projecting an image of the mask pattern to exposure area on the substrate by causing the pattern light, which travels from the inside of the cylindrical mask to the outside thereof, to be incident to a projection optical system; and
holding the substrate so that a portion of the substrate including at least the exposure area is curved to be in a convex shape toward the projection optical system and to correspond to a curvature of the circumferential surface of the cylindrical mask.

42. The exposure method according to claim 41 further comprising,
projecting an intermediate image of the mask pattern to the exposure area on the substrate by an image forming optical system that is disposed inside the hollow cylindrical mask, causes the patterned light for exposure generate from the mask pattern to be incident, and forms the intermediate image of the mask pattern adjacent to the circumferential surface of the cylindrical mask.

43. The exposure method according to claim 42,
wherein a plurality of mask patterns separated in a direction of the axis line are disposed on the circumferential surface of the hollow cylindrical mask so that relative positions therebetween are shifted in a circumferential direction of the circumferential surface
and wherein a plurality of pairs of the projection optical systems and the image forming optical systems are provided to correspond to the plurality of mask patterns, respectively.
